(19) United States
(12) Patent Application Publication
(10) Pub. No.: US 2026/0353050 A1
(43) Pub. Date: Nov. 5, 2026

(54) METHOD AND DEVICES FOR DETERMINING A RESPECTIVE DISTANCE VALUE, WHICH REPRESENTS THE DISTANCE BETWEEN A VEHICLE TRANSCEIVER ON A VEHICLE AND A MOBILE DEVICE TRANSCEIVER, BY EXCHANGING MESSAGES

(71) Applicant: AUMOVIO Germany GmbH, Frankfurt am Main (DE)

(72) Inventor: Stefan Hammes, Regensburg (DE)

(73) Assignee: AUMOVIO Germany GmbH, Frankfurt am Main (DE)

(21) Appl. No.: 19/485,105

(22) PCT Filed: May 14, 2024
(86) PCT No.: PCT/DE2024/200039

§ 371 Date: Nov. 17, 2025

(30) Foreign Application Priority Data
May 24, 2023 (DE) 102023204841.8

(51) Int. Cl. H04W 4/40; G01S 13/02

(52) U.S. Cl. CPC H04W 4/40; G01S 13/0209

(57) ABSTRACT

A method and a device designed to determine at least one current distance value, which represents the distance between a mobile device transceiver and a vehicle transceiver on a vehicle, by exchanging messages, wherein the intervals at which distance values are determined last more than one second.

### CROSS-REFERENCE TO RELATED APPLICATIONS

This application is the U.S. National Phase application of PCT International Application No. PCT/DE2024/200039, filed May 14, 2024, which claims priority to German Patent Application No. 102023204841.8, filed May 24, 2023, the contents of such applications being incorporated by reference herein.

### FIELD OF THE INVENTION

The application relates to methods and devices for determining a respective distance value which represents the distance between a vehicle transceiver on a vehicle and a mobile device transceiver, by exchanging messages.

### BACKGROUND OF THE INVENTION

The determination of a distance between a vehicle transceiver and a mobile device transceiver (e.g. smartphone, SmartWatch, ID transducer (e.g. vehicle key, keyfob)) by means of UWB ToF (Time of Flight) can be organized, for example, in a so-called “UWB ranging session”, which can define, inter alia, the temporal behavior (ranging cycle, repetition rate, etc.) when exchanging messages for distance determination.

The localization of mobile device transceivers such as in particular smart devices (SO) by ultra-wide band (UWB) is based, for example, on distance measurement using the so-called Time of Flight (ToF) measurement method with, for example, a so-called “ranging”.

Such a distance measurement can be used, for example, only for a limited time, for example for 30 s. After this time has elapsed, the localization is paused, that is to say at least temporarily/momentarily terminated.

If the localization is then to be resumed, for example after an action by the vehicle user (pull on the door handle, actuation of the start pedal or start button or the like), it can take several seconds until the measurement is started again and until the mobile device transceiver has been localized.

According to the currently used standard (CCC TS-101, R3 V1.1.0), incorporated herein by reference, the establishment of what is known as the ranging session is shortened by virtue of certain parameters that are necessary for the establishment of the ranging session not being transmitted or not being transmitted completely. Furthermore, this specification describes a way of stipulating the joint time reference of SO and vehicle before the start of the ranging session by using another communication channel (BlueTooth Low Energy, BLE).

### SUMMARY OF THE INVENTION

One aspect of the invention aims to optimize a determination of a distance value (representing a distance between at least one motor vehicle transceiver on a motor vehicle and a mobile device transceiver outside the motor vehicle). This aspect is achieved by the subject matter of the independent claims. Some particularly advantageous embodiments of the invention are specified in the dependent claims and in the description. As alternatives to existing solutions, embodiments of the invention can make it possible to determine a distance and/or a time of flight between a vehicle and a (mobile device) transceiver, which is more energy-efficient in comparison with the current standard and can therefore make a temporary termination/interruption of the ranging etc. unnecessary.

With respect to some embodiments of the invention according to the dependent claims:

According to one embodiment of the invention, intervals in which distance value determinations take place are longer than one second only if an earlier distance value has already been determined beforehand using vehicle transceivers, whereas the intervals otherwise preferably amount to less than one second, in particular 192 ms.

For example, if the user of a vehicle has already been detected as being in the vehicle on the basis of distance determinations, a less frequent new distance determination (whenever or if an action such as starting a motor vehicle is detected) every one to x (multiple) seconds may be sufficient.

For example, according to embodiments of the invention, intervals can be more than one or more than two or more than three or more than five or more than ten or more than thirty seconds long, and/or intervals can be less than two or less than three or less than five or less than ten or less than thirty seconds long.

According to further embodiments of the invention, the intervals can be changed dynamically while a distance value determination is in progress (for example an ongoing ranging), in particular depending on whether the mobile device transceiver is moving toward or moving away from the vehicle.

The movement (toward or away) can be communicated, for example, by at least one message between the mobile device transceiver and the vehicle via a Bluetooth or Bluetooth BLE channel or other channel.

For example, when the mobile device transceiver is moving toward the vehicle, the intervals may be shorter than when the mobile device transceiver is moving away from the vehicle, or vice versa. And/or if the mobile device transceiver does not move (or moves scarcely, or does not move beyond a limit value) relative to the vehicle, the intervals can then be longer.

Further features and advantages of some advantageous embodiments of the invention will be apparent from the following description of some exemplary embodiments of the invention based on the drawings.

### BRIEF DESCRIPTION OF THE DRAWINGS

In particular, to illustrate some possible embodiments of the invention:

FIG. 1 shows an embodiment according to the invention of a transmission of messages between a mobile device transceiver and vehicle transceivers for distance determination,

FIG. 2 shows an embodiment according to the invention of a distance determination based on the exchange of, for example, three messages and here possibly also of transmission/reception times in a simple ranging session,

FIGS. 3-8 each show an embodiment according to the invention of a transmission of messages between a mobile device transceiver and one or more vehicle transceivers for distance determination.

### DETAILED DESCRIPTION OF EXEMPLARY EMBODIMENTS

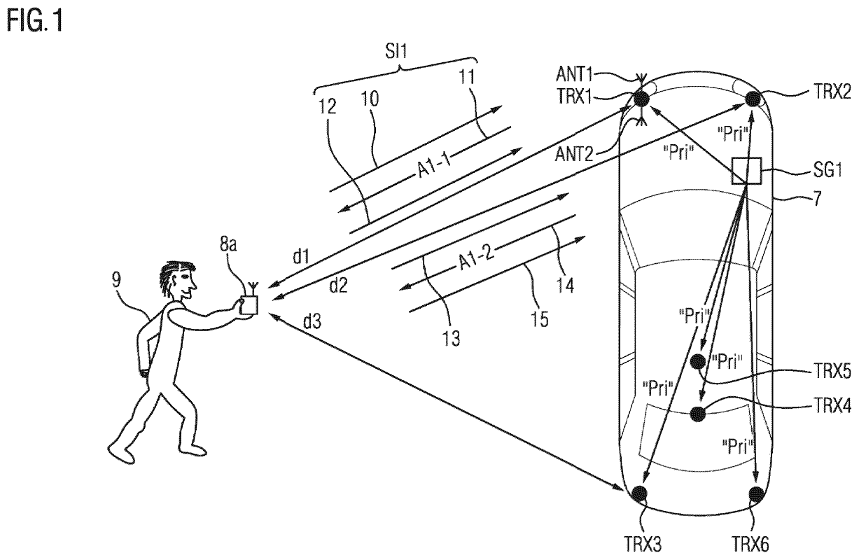

FIG. 1 shows, by way of example, how a number of messages 10,11,12; 30, 31, 32; 40, 41, 42; 13, 14, 15 (using, for example, UWB/UltraWideBand) are exchanged between one (TRX1) of multiple vehicle transceivers (TRX1, TRX2, TRX3, TRX4, TRX5, TRX6) of a (motor) vehicle 7 and a mobile device transceiver 8a (for example a mobile phone, a smartphone, a smartwatch, a watch, an ID transducer, a vehicle key, a key fob, etc.) of a user (9), to determine at least one distance value d1 (e.g., distance d1 or message time of flight) representing a distance d1 between the mobile device transceiver 8a and the vehicle transceiver TRX1.

Accordingly, it is possible, if required, for messages 13, 14, 15 to also be exchanged (e.g., by UWB/UltraWideband) between a further one (TRX2) of multiple vehicle transceivers (also referred to as anchors) of the (motor) vehicle 7 and the mobile device transceiver 8a, in order to determine a distance value d2 (e.g., distance d2 or message time of flight) representing a distance d2 between the mobile device transceiver 8a and the vehicle transceiver TRX2.

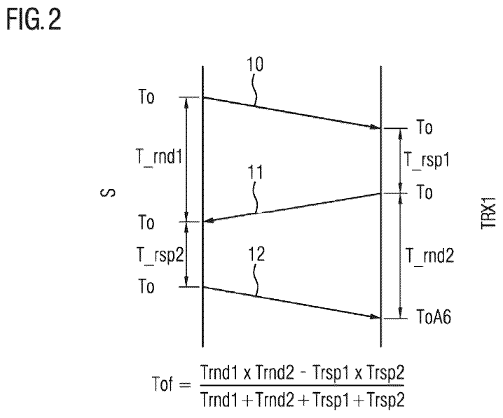

From one or more distance values d1, d2, . . . the position of the mobile device transceiver 8a relative to at least one vehicle transceiver TRX1 and/or to/in the vehicle 7 (or to the vehicle center) can be determined (for example by triangulation), for example by a control device SG1, which control device SG1 can receive, for example, information relating to signal time of propagation (such as the ToF or some/all of the T_rnd1, T_rsp1, T_rnd2, T_rsp2 . . . etc. in FIG. 2) or distance values d1, d2, . . . of vehicle transceivers TRX1, TRX2, TRX3, TRX4, . . . .

Position determination can comprise, for example, determining whether the mobile device transceiver 8a is located in the space outside the vehicle 7 or in the interior space inside the vehicle 7. For example, in order to allow vehicle starting only when the mobile device transceiver 8a is in the interior of the vehicle 7.

Opening (or closing) at least one door or starting of the vehicle 7 can take place, for example, if one or more distances d1, d2, etc. drop below (or exceed in case of closing) a value and/or distances decrease over time and/or further criteria are possibly satisfied.

Communications with different vehicle transceivers and/or the different mobile device transceivers may be distinguishable for example on the basis of IDs or headers which differ depending on the transceiver and are contained in messages, and/or on the basis of specified time slots or in some other way.

Determination of a distance between vehicle transceivers on a vehicle and a mobile device transceiver by means of a so-called TimeOfFlight (ToF) method is described, for example, in DE 10 2021 207 725.0 (202104661) or DE102019211152, which are incorporated in the disclosure of this application by reference.

As shown in FIG. 2, it is possible for example to calculate (for example in a vehicle transceiver and/or also in a mobile device transceiver or in a control device SG1) times of flight or time of flight ToF and possibly therefore (d1=c*ToF etc.) distances d1, d2 etc. and/or on the basis of the times at which the individual messages 10, 11, 12, etc. (and corresponding other messages) were sent and received (or on the basis of periods of time between transmission times and reception times such as T_rnd1, T_rsp1, T_rnd2, Trsp2), in particular when (some/reciprocal) transmission and/or reception times are transmitted between the mobile device transceiver 8a and vehicle transceiver TRX1.

For example, time of flight or distances d1 etc. can be calculated using the formula specified in FIG. 2:

$$ToF = ( T\_rnd1 * T\_rnd2 - T\_rsp1 * T\_rsp2 ) / ( T\_rnd1 + T\_rnd2 + T\_rsp1 + T\_rsp2 )$$

The distance d1 is, for example, d1=c*ToF (c=speed of light in air)

This distance calculation can be particularly secure with respect to illegal attempts to open doors. Such a method is also-called “ranging” or “TimeOfFlight ranging”.

The for example three messages in FIG. 2, i.e. 10, 11, 12; 30, 31, 32; 40,41, 42 transmitted (between a mobile device transceiver 8a and a vehicle transceiver TRX1), which allow calculation of a distance value d1 are denoted e.g. as session (German: session) with a session index (German: session index) SI or SI1.

In FIG. 1, 2, for example, the messages 10, 11, 12 (first mobile device transceiver 8a) form a session having the session index SI1.

The determination of a distance between a vehicle transceiver and a mobile device transceiver (e.g. smartphone, SmartWatch, ID transducer (e.g. vehicle key, key fob)) by means of UWB ToF (Time of Flight) can be organized, for example, in a so-called “UWB ranging session”, which can define, inter alia, the temporal behavior (ranging cycle, repetition rate) when exchanging messages for distance determination.

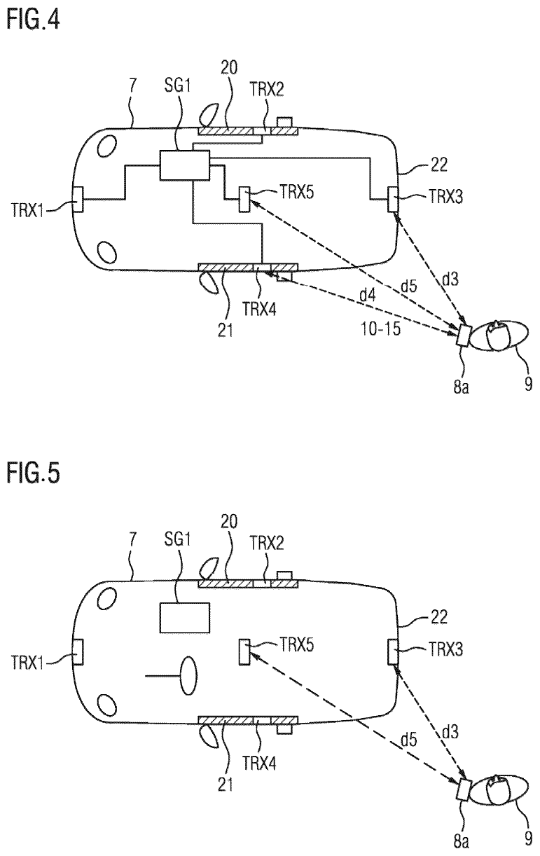

FIG. 4 shows, by way of example, as one exemplary embodiment of the invention, how messages 10,11,12; 30, 31, 32; 40, 41, 42; etc. are exchanged (using, for example, UWB/UltraWideBand) between one (TRX1) of possibly multiple vehicle transceivers (TRX3, TRX4, TRX5) of a (motor) vehicle 7 and a mobile device transceiver 8a (for example, mobile phone, smartphone, smartwatch, watch, ID transducer, motor vehicle key, key fob etc.) belonging to a user 9, in order to determine at least one distance value d3 (for example, distance d3 or message time of flight ToF) representing a distance d3 from the mobile device transceiver 8a to the vehicle transceiver TRX3.

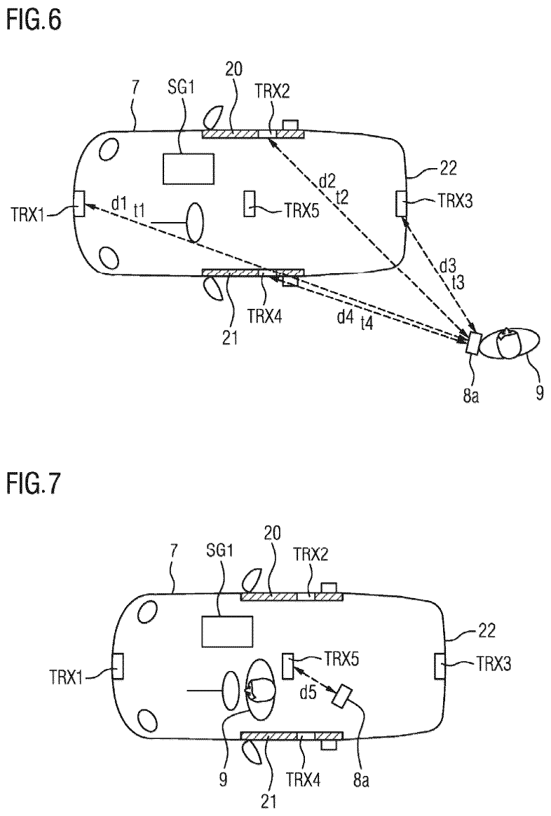

A determination of a respective distance value such as d1 (e.g. in FIG. 1 and FIG. 6) is carried out repeatedly, e.g. at intervals I1, I2 (I1, I2 can be of equal length or be different, for example).

Previously, intervals I1, I2 etc. in which distance value determinations take place, amounted to 192 ms.

The intervals I1, I2 etc. in which distance value determinations take place may however amount to more than one second, in particular several seconds, for example two or three or four or five or six or seven or eight or nine or ten or twenty seconds.

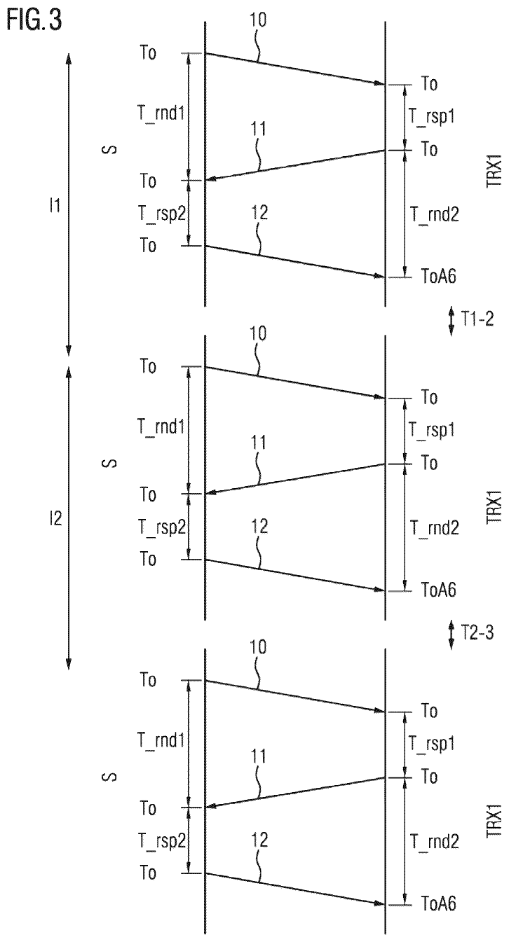

For example, times (T_rsp1 and/or T_rsp2 in FIG. 3) between reception of a signal and transmission of the next signal for distance determination may be at least one second.

Times (T-1-2, T2-3) between the respective end of a distance determination and the start of the next distance determination can also be equal to at least one second or several seconds.

Times (I1, I2) between the respective start of a distance determination and the start of the next distance determination can also be equal to at least one second or several seconds.

The localization of smart devices (also-called SO for short) 8a by means of, e.g., ultra wide band (UWB) is based, for example, on distance measurement by means of the so-called time of flight (ToF) measurement method (“ranging”).

Since this measurement requires energy, it can possibly also be used e.g. only for a limited time in a correspondingly equipped vehicle 7, e.g. for 30 s. After this time has elapsed, the distance determination or localization can be paused, that is to say at least temporarily/momentarily terminated. If the distance determination or localization is now to be resumed, triggered e.g. by an action by the vehicle user (pull on the door handle of a door 20, 21, 22, actuation of the start pedal or start button or the like), it may take some time until the measurement is started again and a localization (by d1, d2, etc.) of the mobile device transceiver (SO) 8a has been effected.

According to the currently used standard (CCC TS-101, R3 V1.1.0), the establishment of what is known as the ranging session is shortened by virtue of certain parameters that are necessary for the establishment of the ranging session not being transmitted or not being transmitted completely. Furthermore, this specification describes a way of stipulating the common time reference between the mobile device transceiver (SO) 8a and the vehicle 7 before the start of a current ranging session via another communication channel (BlueTooth Low Energy, BLE).

By way of example, the localization of the mobile device transceiver (SO) 8a was successful at least once beforehand, that is to say at least one (earlier) distance d1 (and/or d2, d3, d4, d5, etc.) could be determined at least once, and/or the mobile device transceiver 8a could be uniquely associated with the interior space (space in the vehicle 7) and/or, as in FIG. 4, with the exterior space (region outside the vehicle 7).

It is then possible, for example, as in FIG. 5, to determine at least one current distance value d1 etc. (e.g. a time of flight or distance) between a respective vehicle transceiver TRX1-TRX4, in the exterior space (outside the vehicle 7), and a mobile device transceiver 8a, for example, after a detected action of a vehicle user 9.

It is also possible, for example, to determine as a sequence in succession with in each case one distance value determination, then in each case only the distance (of the mobile device transceiver 8a) from another of the vehicle transceivers TRX1-TRX4 in the exterior (or TRX1-TRX5), or else, for example, the distance from in each case two other (than last) of the vehicle transceivers TRX1-TRX4 in the exterior space.

Furthermore, a control device (for example SG1) can monitor the state of the vehicle entrances (doors 20, 21, trunk 22, etc.) 20, 21, 22 of the vehicle 7.

In the case of closed vehicle entrances 20, 21, 22 and mobile device transceiver (SO) 8a detected in a sufficiently reliable manner in the exterior, e.g. only the current distance d3 from, for example, (at least) one of the transceivers (“anchors”) TRX3 assigned to the exterior or located in the exterior space is determined, as in FIG. 4, and possibly e.g. a further distance d5 from a further transceiver TRX5 located in the exterior or in the interior space.

For example, in the case of closed vehicle entrances 20, 21, 22 and if the mobile device transceiver 8a is sufficiently clearly detected in the interior, then for example only the current distance d5 from one of the “anchors” TRX5 (of the UWB measuring system of the vehicle 7) arranged in the interior is determined for functions such as vehicle access or vehicle starting (e.g. release of the immobilizer), for example as in FIG. 6. It is thus possible to establish e.g. whether the mobile device transceiver 8a is still in the interior of the vehicle 7. Alternatively or additionally, it is also possible to determine a current distance d3 from, for example, (at least) one of the transceivers (“anchors”) TRX3 associated with the exterior space or located in the exterior space.

Instead of complete localization, only a distance measurement of distance values (d1, d2, d3), for example, is carried out using one or a few (fewer than all) anchors in the interior space or in the exterior space or in the interior space and in the exterior space.

This means that the ranging session can be maintained over a longer period of time or permanently or e.g. until the vehicle 7 departs etc., without the same energy being required as in the case of complete localization.

As long as the vehicle entrances 20-22 remain closed, the system assumes for example that the association of the mobile device transceiver (SO) 8a with the exterior or interior space that was determined during the previous localization (position determination by triangulation etc. with earlier distance values) is still valid, i.e. that the mobile device transceiver (SO) 8a is still located or situated in the exterior or interior space, for example. As a result, a reaction time of the system SG1 to an action (for example engine start, accelerator pedal, etc.) of the vehicle user 9 can be shortened.

Furthermore, it would also be conceivable—but not generally recommended for reasons of theft protection—to stop the distance measurement completely and to rely only on the fact that the connection of the mobile device transceiver (SO) 8a to the vehicle 7 by BLE (Bluetooth, Bluetooth Low Energy) represents a sufficient criterion for determining that the mobile device transceiver (SO) 8a is still in the previously determined zone (exterior or interior space).

Since the distance measurement using only a single anchor in the exterior space could also turn out to be only suboptimal under certain circumstances, the distance measurement in the exterior can advantageously be distributed in turn or alternately to vehicle transceivers TRX1-TRX4 (anchors) associated with the exterior space.

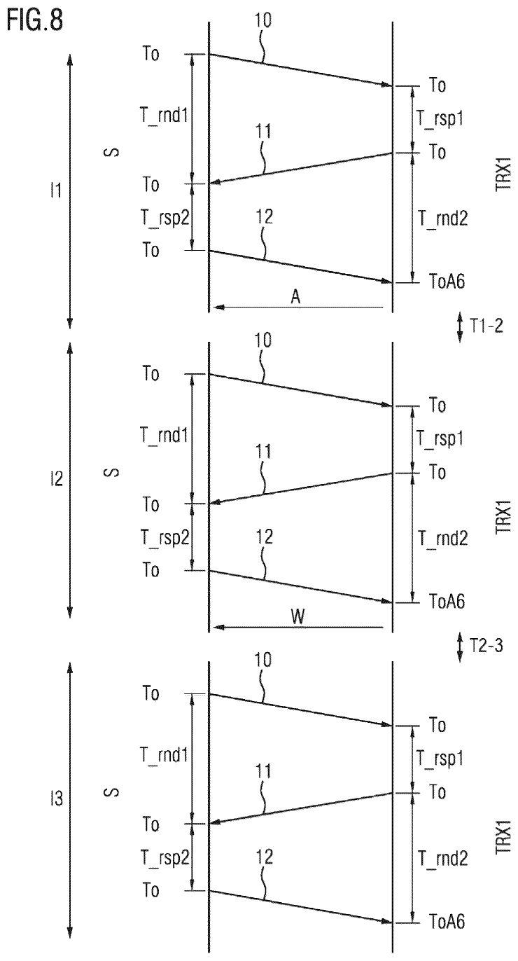

According to further embodiments of the invention, as shown in an example in FIG. 8, the intervals I1, I2, I3 can be changed dynamically while a distance value determination is in progress (for example an ongoing ranging), in particular depending on whether the mobile device transceiver 8a is moving toward or moving away from the vehicle 7 or is hardly moving or not moving at all.

The movement (whether toward or away or absent) can be communicated, for example, by at least one message A, W (movement toward the vehicle: message A, movement away from the vehicle: W in FIG. 8) between the mobile device transceiver 8a and the vehicle 7 via a Bluetooth or Bluetooth BLE channel or another channel (for example also via the (UWB, etc.) channel used for ranging).

For example, when the mobile device transceiver 8a is moving (A) toward the vehicle 7, the intervals I2 may be shorter than the intervals I3 when the mobile device transceiver 8a is moving away from the vehicle 7 (W), or vice versa. And/or if the mobile device transceiver 8a does not move (or hardly moves or moves with a speed below a limit value) relative to the vehicle 7, the intervals I3 can then be longer.

1. A device designed to determine at least one current distance value representing a distance between
a mobile device transceiver and a vehicle transceiver on a vehicle by exchanging messages,
wherein intervals in which distance values are determined last more than one second.

2. The device according to claim 1,
wherein the intervals in which distance value determinations take place are on average and/or all more than one second, in particular several seconds long.

3. The device according to claim 1, wherein intervals are more than one or more than two or more than three or more than five or more than ten or more than thirty seconds long.

4. The device according to claim 1, wherein intervals are less than two or less than three or less than five or less than ten or less than thirty seconds long.

5. The device according to claim 1, wherein all intervals in which distance value determinations take place are more than one second long, or at least all intervals from one point in time.

6. The device according to claim 1, wherein times between reception of a signal and transmission of the next signal for distance determination are at least one second long.

7. The device according to claim 1, wherein times between the respective end of one distance determination and the start of the next distance determination are at least one second long.

8. The device according to claim 1, wherein intervals in which distance value determinations take place last more than one second,
only if at least one earlier distance value has already been determined beforehand using vehicle transceivers, and/or if the mobile device transceiver has been detected as being in the motor vehicle, and/or if the mobile device transceiver has been detected as being at a certain distance from the motor vehicle.

9. The device according to claim 1, wherein the device is designed to determine a current distance value using more than one but fewer than all of the vehicle transceivers if an earlier distance value has already been determined beforehand using vehicle transceivers.

10. The device according to claim 1, wherein the device is configured to determine a current distance value using less than all and/or fewer than the last used vehicle transceivers, if an earlier distance value has already been determined beforehand using vehicle transceivers, and then a determination of distance values was paused.

11. The device according to claim 1, wherein the device is designed so that the determination of a current distance value is carried out by means of a TimeOfFlight determination and/or a ranging.

12. The device according to claim 1, designed in such a way that an association of the mobile device transceiver with the space outside the vehicle or with the interior space inside the vehicle), which association was established during a previous distance value determination and/or localization, is defined as still valid in the current distance value determination.

13. The device according to claim 1, designed in such a way that a current distance value and/or a determined position in the interior or exterior space, determined using less than all and/or fewer than the last used vehicle transceivers is taken into account only if the vehicle entries of the vehicle are detected as closed,
otherwise, the present distance value is ignored and/or a current distance value is determined using several or all vehicle transceivers.

14. The device according to claim 1, designed in such a way that the determination of a current distance value takes place in response to a detected action of a user of the vehicle, in particular after detection of starting of the vehicle engine or detection of a pull on the door handle or detection of actuation of the start pedal or starting button of the vehicle.

15. The device according to claim 1, designed in such a way that a determination of the current distance value outside the vehicle takes place multiple times each time using a different vehicle transceiver or anchor located outside the vehicle.

16. The device according to claim 1, designed in such a way that the mobile device transceiver is a cellular mobile radio terminal and/or a smartphone and/or a vehicle key.

17. The device according to claim 1, designed in such a way that the intervals are changed dynamically during a distance value determination in progress, preferably during a ranging,
in particular depending on whether the mobile device transceiver is moving toward or away from the vehicle,
which movement is preferably communicated by means of at least one message between the mobile device transceiver and the vehicle via a Bluetooth channel or another channel.

18. A method for determining at least one current distance value which represents a distance between a vehicle transceiver on a vehicle and a mobile device transceiver by exchanging messages,
in particular with a device according to claim 1,
wherein intervals at which distances are determined last more than one second.
